(19) United States
(12) Patent Application Publication
(10) Pub. No.: US 2014/0368488 A1
(43) Pub. Date: Dec. 18, 2014

(54) INFORMATION PROCESSING SYSTEM AND DRIVING METHOD THEREOF

(71) Applicant: Semiconductor Energy Laboratory Co., Ltd., Atsugi-Shi (JP)

(72) Inventors: Ryo HATSUMI, Hadano (JP); Shuji Fukai, Atsugi (JP); Daisuke Kubota, Atsugi (JP)

(21) Appl. No.: 14/300,583

(22) Filed: Jun. 10, 2014

(30) Foreign Application Priority Data
Jun. 14, 2013 (JP) 2013-125206

(51) Int. Cl. G09G 3/36

(52) U.S. Cl. CPC G09G 3/3696
USPC 345/212

(57) ABSTRACT

To provide an information processing system allowing eye-friendly display. The information processing system includes a liquid crystal display device (LCD) as a display unit. An image can be displayed in the LCD by at least two driving methods: a first driving method in which data is sequentially rewritten every frame; and a second driving method in which rewriting of data is stopped after data is rewritten once or more times at the same refresh rate as the first driving method. After the display by the second driving method, each pixel is inversely driven plural times by a signal with an amplitude greater than or equal to 80% and less than or equal to 100% of the maximum amplitude of the data signal, whereby degradation of a liquid crystal material is repaired.

### BACKGROUND OF THE INVENTION

1. Field of the Invention

The present invention relates to a semiconductor device, a driving method of the same, and the like. The present invention particularly relates to an information processing system as a semiconductor device, and a driving method of the same. The information processing system includes a liquid crystal display device as a display unit.

In this specification, a semiconductor device means a circuit including a semiconductor element (e.g., a transistor or a diode) and a device including the circuit. The semiconductor device also refers to any device that can function by utilizing semiconductor characteristics. Examples of the semiconductor device include an integrated circuit, a chip including an integrated circuit, a display device, a light-emitting device, a lighting device, and an electronic device.

2. Description of the Related Art

Low-power consumption is an added value of a liquid crystal display device. For example, it has been reported that a reduction in power consumption is achieved by reducing the frequency of data rewriting in a period during which a still image is displayed (see the following references).

### REFERENCES

### Patent Documents

[Patent Document 1] Japanese Published Patent Application No. 2011-141522
[Patent Document 2] Japanese Published Patent Application No. 2011-237760

### Non-Patent Document

[Non-Patent Document 1] S. Amano et al., “Low Power LC Display Using In—Ga—Zn-Oxide TFTs Based On Variable Frame Frequency”, SID International Symposium Digest of Technical Papers, 41 (2010), pp. 626-629

### SUMMARY OF THE INVENTION

With the development of information society, terminals such as smartphones and personal computers have been more commonly used than paper as data media. This forces us to take a close look at a screen for a long time, causing daily eye fatigue. The eye fatigue is caused by multiple factors, as one of which screen flicker is known.

In a display device, a displayed image is changed several tens of times per second. The number of times an image is changed per second is called a refresh rate. As disclosed in the above references, a reduction in refresh rate is effective for reducing screen flicker.

In view of the above background, an object of one embodiment of the present invention is to provide a semiconductor device allowing eye-friendly display, and a driving method of the semiconductor device. Another object of one embodiment of the present invention is to provide a semiconductor device allowing a reduction in power consumption, and a driving method of the semiconductor device.

Note that the description of a plurality of objects does not mutually preclude the existence. One embodiment of the present invention does not necessarily achieve all the objects listed above. Objects other than those listed above are apparent from the description of the specification, drawings, and claims, and also such objects could be an object of one embodiment of the present invention.

One embodiment of the present invention is an information processing system including a liquid crystal display device. The liquid crystal display device includes at least two display modes: a first display mode in which a data signal is sequentially input to a pixel circuit at a first refresh rate; and a second display mode in which the input of a data signal to the pixel circuit is stopped after data is written to the pixel circuit by inputting a data signal once or more times at the first refresh rate. A controller has a function of controlling a gate driver and a source driver to change the display mode. The control with the controller is as follows: after display in the second display mode, display in the first display mode is performed in a first period; and in successive frame periods in the first period, the pixel circuit is inversely driven at a first refresh rate by a signal with an amplitude greater than or equal to 80% and less than or equal to 100% of the maximum amplitude of the data signal.

In the above embodiment, the controller can stop the supply of a power source to the gate driver and/or the source driver during a period in which the input of a data signal to the pixel circuit is stopped in the second display mode.

In the above embodiment, a transistor whose off-state current per micrometer of channel width is lower than or equal to 100 zA (100×10⁻²¹ A) may be provided as a switching element in the pixel circuit. Alternatively, a transistor in which a channel is formed using an oxide semiconductor may be provided.

In the above embodiment, a liquid crystal element preferably includes a liquid crystal material having a specific resistivity greater than or equal to 1.0×10¹³ Ω·cm.

Another embodiment of the present invention is a method for driving an information processing system including a liquid crystal display device. Display of the liquid crystal display device is performed at least by a first driving method and a second driving method. In the first driving method, data of a pixel circuit is sequentially rewritten at a first refresh rate. In the second driving method, rewriting of the pixel circuit is stopped after data of the pixel circuit is rewritten once or more times at the first refresh rate. A first image is displayed by the second driving method, and then a second image is displayed by the first driving method. In successive frame periods in the display period of the second image, the pixel circuit is inversely driven at the first refresh rate by a first signal. The first signal has an amplitude greater than or equal to 80% and less than or equal to 100% of the maximum amplitude of a signal input as data to the pixel circuit.

According to one embodiment of the present invention, a semiconductor device allowing eye-friendly display and a driving method thereof can be provided.

### BRIEF DESCRIPTION OF THE DRAWINGS

In the accompanying drawings:

FIG. 1 is a block diagram illustrating an example of a configuration of an information processing system;

FIG. 2A is a block diagram illustrating an example of a structure of an LCD, FIG. 2B is a circuit diagram illustrating an example of a structure of a pixel circuit in the LCD, and FIG. 2C is a plan view illustrating an example of a structure of a liquid crystal panel;

FIGS. 3A and 3B are schematic views showing examples of a driving method of the LCD by a normal drive and an IDS drive, respectively;

FIGS. 4A and 4B are timing charts showing examples of the driving method of the LCD by the normal drive and the IDS drive, respectively;

FIG. 5 is a schematic view showing an example of a method for switching between images;

FIGS. 6A and 6B are respectively a layout of a pixel circuit and a cross-sectional view of a liquid crystal panel, which are included in an example of an LCD using an FFS mode; and

FIGS. 7A to 7F are external views illustrating specific examples of the information processing system.

### DETAILED DESCRIPTION OF THE INVENTION

Hereinafter, embodiments of the present invention will be described in detail with reference to the accompanying drawings. Note that the present invention is not limited to the following description, and it is easily understood by those skilled in the art that modes and details of the invention can be modified in various ways. Therefore, the present invention is not construed as being limited to the description of the following embodiments.

In the drawings used for the description of embodiments of the present invention, the same portions or portions having similar functions are denoted by the same reference numerals, and description thereof is not repeated.

### Embodiment 1

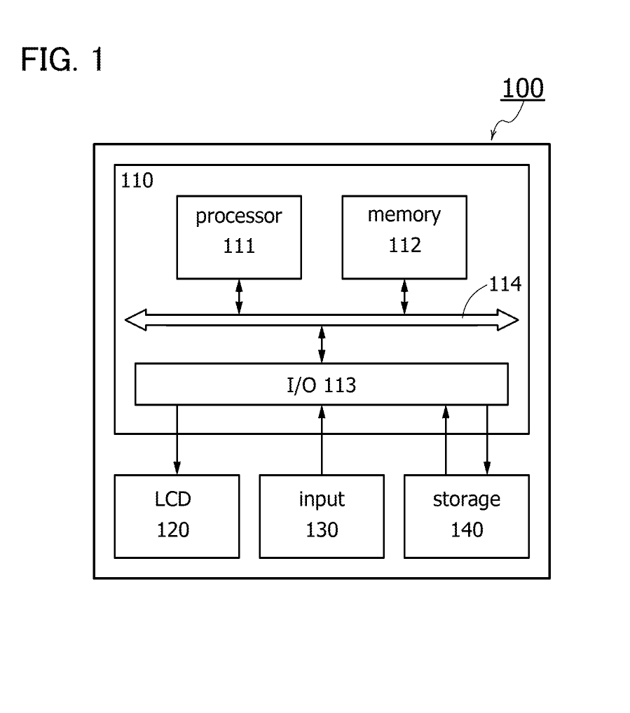

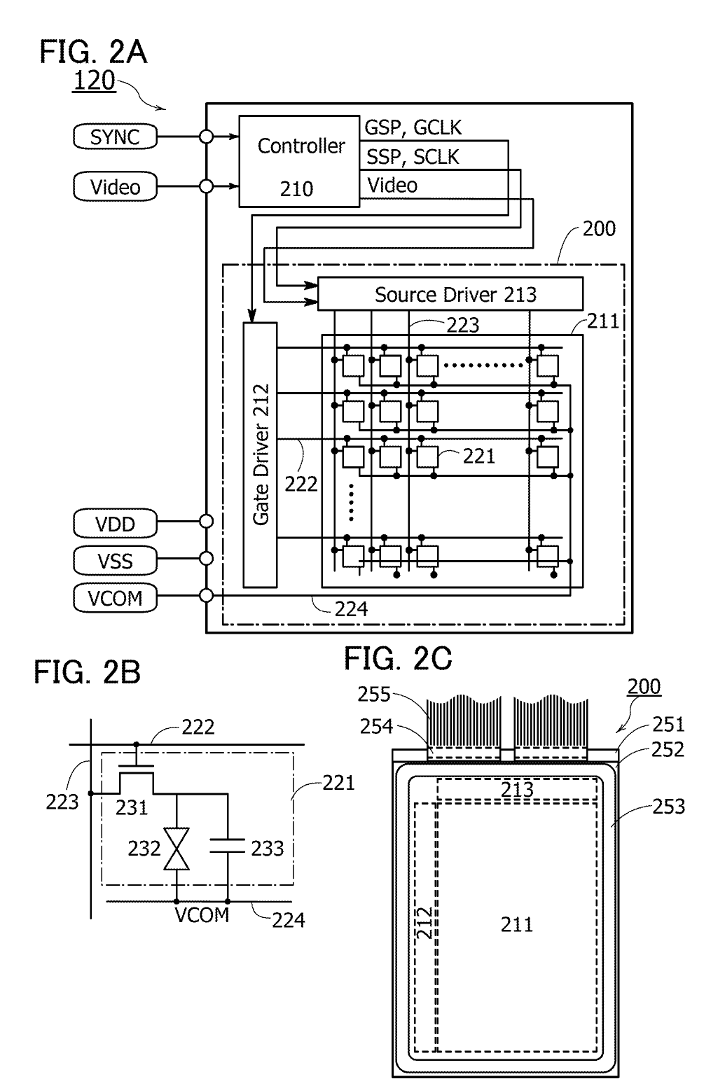

In this embodiment, a display device and an information processing system including the display device will be described as examples of a semiconductor device. This embodiment will be described below with reference to FIG. 1, FIGS. 2A to 2C, FIGS. 3A and 3B, FIGS. 4A and 4B, and FIG. 5.

### <Information Processing System>

FIG. 1 is a block diagram illustrating an example of a configuration of the information processing system in this embodiment. An information processing system 100 includes an arithmetic unit 110, a liquid crystal display device (LCD) 120, an input unit 130, and a storage unit 140.

The arithmetic unit 110 has a function of controlling the whole information processing system 100. The arithmetic unit 110 includes a processor 111, a memory unit 112, an input/output (I/O) interface 113, and a bus 114. Via the bus 114, the processor 111, the memory unit 112, and the I/O interface 113 are connected to each other. The arithmetic unit 110 communicates with the LCD 120, the input unit 130, and the storage unit 140 via the I/O interface 113. For example, a signal input to the input unit 130 is transferred to the processor 111 or the memory unit 112 via the I/O interface 113 and the bus 114.

Retained in the memory unit 112 are data (including programs) necessary for processing of the processor 111 and data input via the I/O interface 113.

The processor 111 executes a program to operate the information processing system 100. The processor 111, for example, analyzes a signal input to the input unit 130, reads data from the storage unit 140, writes data to the memory unit 112 and the storage unit 140, or generates a signal output to the LCD 120.

The LCD 120 is provided as an output unit and constitutes a display portion of the information processing system 100. The information processing system 100 may include another output unit such as a speaker or a printer in addition to the display unit.

Data is input to the arithmetic unit 110 from the input unit 130. A user can operate the information processing system 100 by operating the input unit 130. Various human interface devices can be used as the input unit 130, and the information processing system 100 may include a plurality of input units. Examples of the input unit 130 include a touch panel, a keyboard, and an operation button which can be operated by a user directly so as to operate the information processing system 100. The information processing system 100 may be operated with another input unit including a device that senses sound, eye movement, gesture, or the like, e.g., with a microphone or a camera (imaging system).

Various data such as programs or image signals are retained in the storage unit 140. The capacitance of the storage unit 140 is larger than that of the memory unit 112. Examples of the storage unit 140 include a flash memory, a DRAM, and a hard disc (HDD). The storage unit 140 may be provided as needed.

The information processing system 100 may be a device in which all the units such as the arithmetic unit 110 are incorporated in a housing, or a device in which some units are connected to the arithmetic unit 110 via wires or wirelessly. Examples of the former include a laptop personal computer (PC), a tablet PC (terminal), a smartphone, and an e-book reader. Examples of the latter include a set of a desk-top PC, a keyboard, a mouse, and a monitor.

In the information processing system 100, the LCD 120 can be driven by at least two methods: one is a normal display mode in which data of a pixel (pixel circuit) is rewritten periodically by inversion driving every frame; and in the other method, data rewriting is stopped after data of a pixel is rewritten once or more times.

A structure of the LCD 120 and a driving method thereof will be described below.

### <Example of Structure of LCD>

FIG. 2A is a block diagram illustrating an example of the structure of the LCD 120. As illustrated in FIG. 2A, the LCD 120 includes a liquid crystal (LC) panel 200 and a controller 210. The LCD 120 also includes a backlight module and the like. The LC panel 200 includes a pixel portion 211, a gate driver 212, a source driver 213, a gate line 222, a source line 223, and a common line 224.

Input to the LCD 120 are an image signal (Video), a synchronization signal (SYNC) for controlling the rewriting of data in the LC panel 200, and a control signal such as a reference clock signal (CLK). Examples of the synchronization signal include a horizontal synchronization signal and a vertical synchronization signal. In addition, a high power source voltage (VDD), a low power source voltage (VSS), and a common voltage (VCOM) are input to the LCD 120 from an external power control unit.

In the following description, the high power source voltage (VDD) is also simply referred to as VDD or a voltage VDD. The same applies to another voltage, signal, circuit, and the like.

The pixel portion 211 includes a plurality of pixel circuits 221 arranged in an array. The pixel circuits 221 in the same row are connected to the gate driver 212 through a common gate line 222, and the pixel circuits 221 in the same column are connected to the source driver 213 through a common source line 223.

The controller 210 controls the whole LCD 120 and generates signals for controlling circuits in the LCD 120. The controller 210 includes a control signal generation circuit in which signals for controlling the drivers (212, 213) are generated from the synchronization signal (SYNC). The synchronization signal (SYNC) is a vertical synchronization signal, a horizontal synchronization signal, a reference clock signal, or the like.

In the controller 210, a start pulse (GSP), a clock signal (GCLK), and the like are generated as signals for controlling the gate driver 212, and a start pulse (SSP), a clock signal (SCLK), and the like are generated as signals for controlling the source driver 213. Note that such signals may each be a group of signals instead of a single signal.

The controller 210 also includes a power control unit and controls the supply of a power source voltage to the drivers (212, 213) and the suspension thereof.

When GSP is input to the gate driver 212, a gate signal is generated in accordance with GCLK and output to each gate line 222 sequentially. The gate signal selects the pixel circuit 221 to which a data signal is to be written.

The source driver 213 processes an image signal (Video) to generate a data signal and outputs the data signal to the source line 223. When SSP is input to the source driver 213, a data signal is generated in accordance with SCLK and output to each source line 223 sequentially.

The pixel circuit 221 includes a switching element, and the connection between the switching element and the source line 223 is controlled by a gate signal. When the switching element is turned on, a data signal is written to the pixel circuit 221 through the source line 223. When the switching element is turned off, the data in the pixel circuit 221 is retained.

### <Example of Structure of LC Panel>

In the LCD 120, a circuit block surrounded by a dashed-dotted line in FIG. 2A is modularized as the LC panel 200. FIG. 2C is a plan view illustrating an example of the structure of the LC panel 200.

The LC panel 200 includes a substrate 251 and a substrate 252 facing each other. The substrate 251 and the substrate 252 are fixed by a sealing material 253 with a space therebetween. The substrate 251 is a support substrate of a backplane of the LC panel 200, and the circuits (211 to 213) and a terminal portion 254 are formed over the substrate 251. The terminal portion 254 is connected to a flexible printed circuit (FPC) 255 with a conductive material such as an anisotropic conductive film. Voltage and signals are input to each circuit over the substrate 251 through the FPC 255.

An IC chip including the controller 210 may be mounted on the substrate 251. Alternatively, part or the whole of the drivers (212, 213) may be formed as an IC chip and mounted on the substrate 251. Examples of the mounting methods include a chip on glass (COG) method, a chip on film (COF) method, a wire bonding method, and a tape automated bonding (TAB) method.

### <Example of Structure of Pixel Circuit>

FIG. 2B is a circuit diagram illustrating an example of a structure of the pixel circuit 221. The pixel circuit 221 includes a transistor 231, a liquid crystal element 232, and a capacitor 233.

The transistor 231 is a switching element which controls the connection between the liquid crystal element 232 and the source line 223. The transistor 231 is turned on or off by a gate signal input to its gate. The liquid crystal element 232 has a capacitor structure in which electric charge is accumulated, and includes two electrodes and a liquid crystal interposed therebetween. Here, one of the electrodes of the liquid crystal element 232 is referred to as a pixel electrode, which is connected to the source line 223 through the transistor 231. The other electrode is referred to as a common electrode, to which VCOM is applied through the common line 224. The capacitor 233 is connected in parallel with the liquid crystal element 232 and serves as an auxiliary capacitor of the liquid crystal element 232. One of the electrodes of the capacitor 233 is connected to the source line 223 through the transistor 231 and the other electrode is connected to the common line 224.

### <Image Display Method of Information Processing System (LCD)>

Described below is a method for driving the information processing system with less eye strain. Hereinafter, techniques of displaying images with less eye strain are collectively referred to as a reducing eye strain technology (REST).

According to one of the REST, the frequency of data rewriting is reduced as much as possible. This driving method allows reducing screen flicker due to rewriting of data.

The LCD 120 is driven by at least two methods (modes). One is a conventional driving method of LCD referred to as a “normal drive”, in which data is rewritten sequentially every frame. The other method is referred to as an “idling stop (IDS) drive”, in which data rewriting is stopped after data writing is executed. In a “normal mode (state)” and an “IDS mode (state)”, the LCD 120 is operated by the normal drive and the IDS drive, respectively.

Moving images are displayed by the normal drive. Still images are displayed by the normal drive or the IDS drive. The display mode is selected in the processor 111 in accordance with an instruction from the input of the input unit 130 (operation by a user) or an instruction from the application executed by the information processing system 100. In the LCD 120, the drivers (212, 213) are controlled by the controller 210 so that display is performed in a mode selected in the processor 111.

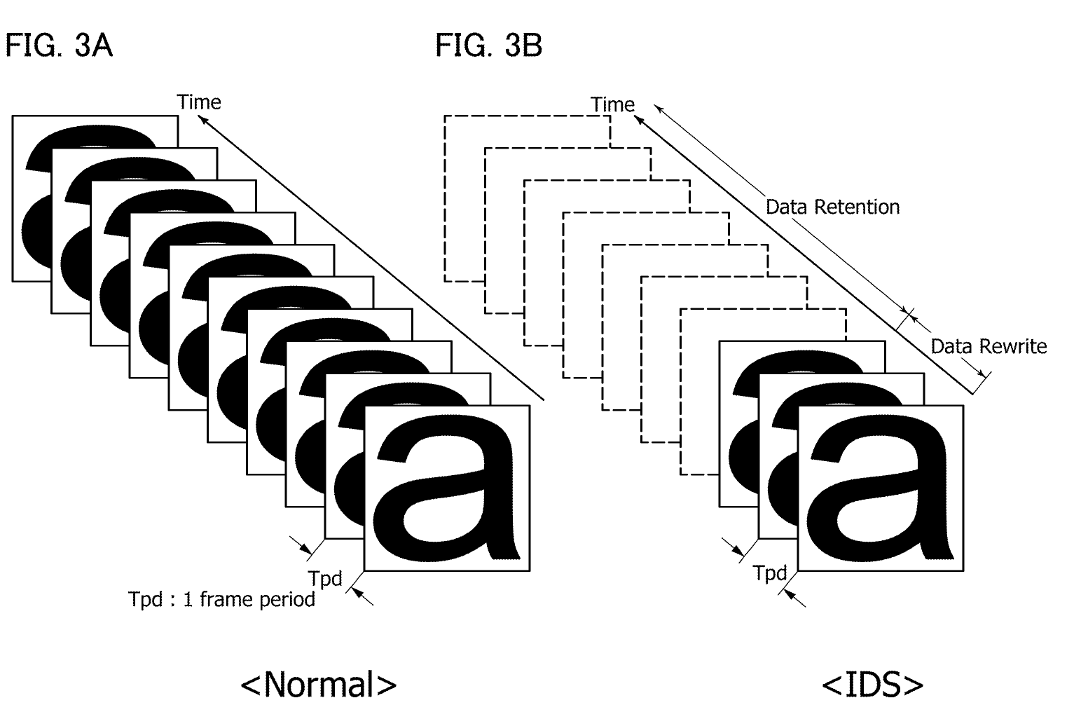

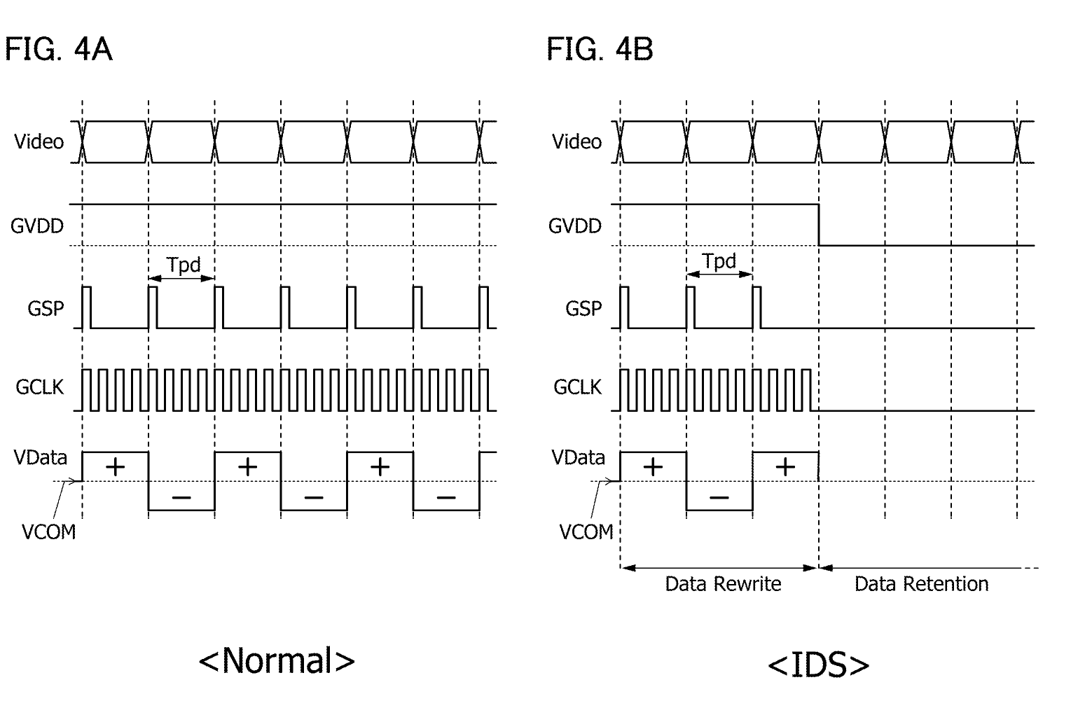

A still image can be displayed without change in image data every frame; thus, it is not necessary to rewrite data every frame. When the LCD 120 is driven in the IDS mode in displaying still images, power consumption can be reduced with less screen flicker. The normal drive and the IDS drive will be described below with reference to FIGS. 3A and 3B and FIGS. 4A and 4B.

FIG. 3A shows a display method of still images by the normal drive, and FIG. 3B shows a display method of still images by the IDS drive.

FIGS. 4A and 4B are timing charts showing examples of the normal drive and the IDS drive, respectively. In FIGS. 4A and 4B, Video is an image signal input to the LC panel 200, GVDD is a high power source voltage of the gate driver 212, and VData is a data signal output from the source driver 213 to the source line 223.

### <Normal Drive>

In the normal drive, data is rewritten every frame period (Tpd). When GSP is input, the gate driver 212 generates a gate signal in accordance with GCLK and outputs the gate signal to the gate line 222. When SSP is input, the source driver 213 generates VData in accordance with SCLK and outputs VData to the source line 223.

As shown in FIG. 4A, the polarity of VData input to each pixel circuit 221 is inverted every frame period. Typical examples of the inversion driving include dot inversion driving, gate line inversion driving, and source line inversion driving.

Here, the polarity of VData is determined on the basis of VCOM. The polarity of VData is positive when the voltage thereof is higher than that of VCOM, and is negative when the voltage thereof is lower than that of VCOM.

### <IDS Drive>

As shown in FIG. 3B and FIG. 4B, the IDS drive includes two kinds of processing: data rewriting processing (also referred to as writing processing) and data retention.

First, data rewriting is executed plural times at the same refresh rate (period Tpd) as the normal drive, whereby data is written to a pixel. After the data writing, generation of gate signals is stopped to suspend data rewriting. As a result, the transistors 231 are turned off in all the pixel circuits 221 so that data is retained.

The number of times data is rewritten may be one or more. In the case where data rewriting is executed twice or more, a data signal is input to the pixel circuit 221 every frame period as in the normal drive. FIG. 3B and FIG. 4B show an example of performing data rewriting three times.

The frequency of data rewriting may be determined depending on the refresh rate or the like. The time required for data rewriting is at most 1 second, and is preferably greater than or equal to 0.5 seconds and less than or equal to 0.2 seconds.

The frequency of data rewriting is adjusted so that the polarity of the last VData written to a pixel is opposite to that of VData that is held in the pixel in the data retention period of the preceding IDS mode. This inhibits degradation of the liquid crystal element 232 due to the IDS drive. For example, in the IDS drive, the number of times data is rewritten is set to an odd number, and the polarity of VData to be rewritten first is set to be opposite to that of VData held in the pixel in the data retention period of the preceding IDS mode. In the case where VData held in the pixel in the preceding IDS mode has negative polarity and the LCD 120 has a refresh rate of 120 Hz, data writing in the IDS mode is performed 59 times (approximately 0.5 seconds) and VData with positive polarity is input for the first data rewriting.

As can be seen from FIGS. 3A and 3B and FIGS. 4A and 4B, in the IDS mode, a still image can be displayed while data is rewritten much less frequently than in the normal mode. Accordingly, display of still images in the IDS mode results in reduced screen flicker and less eye strain.

As shown in FIG. 4B, in the IDS mode, the supply of control signals (GSP, GCLK) from the controller 210 to the gate driver 212 is stopped in the data retention period. Therefore, the controller 210 may stop the supply of the power source voltage GVDD to the gate driver 212 after stopping the supply of control signals (GSP, GCLK). In the data retention period, the supply of control signals (SSP, SCLK) to the source driver 213 is also stopped; thus, the power source voltage can also be stopped being supplied to the source driver 213. In other words, the IDS drive allows power savings as well as eye-friendly display.

In displaying still images in the IDS mode, to eliminate flicker due to screen switching, data rewriting is stopped after data is written to pixels until the image data changes. When the displayed image data changes in the data retention period, the power-saving mode is released by the controller 210 and the gate driver 212 and the source driver 213 are operated to rewrite data.

Note that in this specification, the phrase “a signal or voltage is not supplied to a wiring, a terminal, and the like”, means that a signal or voltage that does not have a predetermined level for operating a circuit is applied to the wiring and the like, and/or the wiring and the like are brought into an electrically floating state.

The information processing system 100 which displays still images by the IDS drive is preferably used for reading e-books, viewing photographs taken with a digital camera, and the like. That is, still images are preferably displayed by the IDS drive in the information processing system 100 in the case where the same screen is displayed for a relatively long time and the entire screen is changed by a user.

<Recovery from Degradation of Liquid Crystal>

In the IDS drive, after data rewriting, an electric field continues to be applied to the liquid crystal element 232 in the same direction for a much longer period than one frame period, which might cause deterioration of the characteristics of a liquid crystal. To inhibit the degradation of the liquid crystal, after a still image is displayed by the IDS drive, processing for repairing the degradation is performed in displaying a moving image to switch between still images. In this processing, a voltage signal with the maximum amplitude is supplied as a data signal so that each pixel circuit 221 in the pixel portion 211 is inversely driven plural times. The application of such a voltage signal allows liquid crystal molecules to move or rotate as largely as possible, thereby recovering the characteristics of the liquid crystal. Such a driving method of the LCD 120 will be described below.

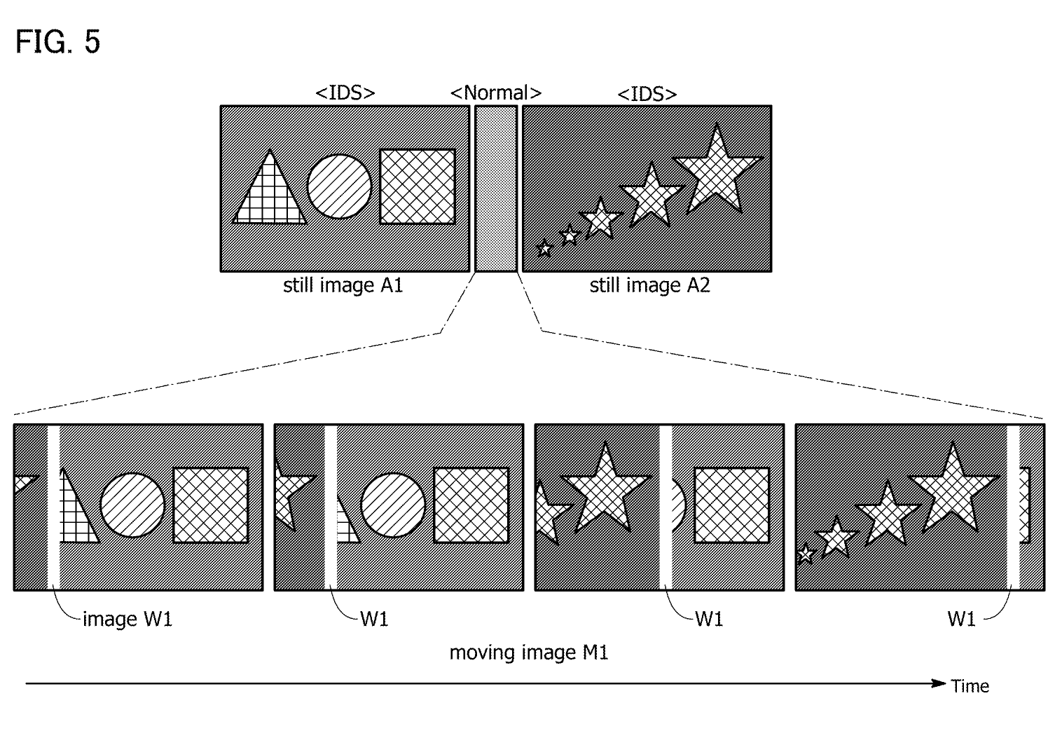

FIG. 5 is a schematic view showing an example of a method in which a still image is displayed after another still image is displayed on the entire screen. In FIG. 5, a still image A1 is switched to a still image A2. The still images A1 and A2 are displayed by the IDS drive. An image for switching between still images, which is a moving image M1 displayed by the normal drive, is displayed between the still image A1 and the still image A2. In the moving image M1 for switching between images, the still image A2 slides from the left to the right of the still image A1.

The still image A1 is switched to the still image A2 by the operation of a user (e.g., tapping on a touch panel or pressing an operation button) or automated processing of the processor 111 by a program (e.g., automatic page turning or beginning of slide show).

In a period during which the moving image M1 is displayed, a voltage signal having the maximum amplitude and the polarity inverted every frame is supplied as a data signal so that pixels are refreshed. The refresh data signal offers the maximum transmittance (white image) when the LCD 120 is in normally-black display, and the minimum transmittance (black image) when the LCD 120 is in normally-white display.

In the period during which the moving image M1 is displayed, data is rewritten by the refresh data signal (refresh signal) twice or more, preferably four times or more, and more preferably ten times or more. The maximum number of times data is rewritten by the refresh signal is limited by the display period of the moving image M1.

Data rewriting by the refresh signal is not necessarily performed in all the pixel circuits 221 simultaneously, and may be performed individually as long as the rewriting by the refresh signal is completed in all the pixels when the display of the moving image M1 is finished. That is, in the normal drive, the refresh signal needs to be input to each pixel circuit 221 at least once in successive frame periods.

FIG. 5 shows an example of the LCD 120 that is in normally-black display. As an example of the moving image M1, a white stripe image W1 moves in the direction in which the still image A2 moves. Pixels where the image W1 is displayed are rewritten by the refresh signal (white data signal). The entire screen of the LCD 120 is thus swept by the image W1, whereby all the pixels are rewritten by the refresh signal at least once.

The image W1 is not necessarily visible to a user as long as the data rewriting by the refresh signal is carried out. It is preferable that the refresh image W1 be displayed without making a user uncomfortable in screen switching. In other words, the moving image (M1) for changing a screen is preferably displayed so that the refresh image W1 seems natural or is invisible to a user. For example, in the case where the information processing system 100 is applied to an e-book, the refresh image W1 may be included in a moving image for turning a page.

Although the moving image (M1) is used for changing a screen in FIG. 5, a still image may also be used. In that case, a data signal of the still image is used as a refresh signal. Accordingly, in changing a screen, the entire screen of the LCD 120 is white in normally-black display, whereas it is black in normally-white display.

In the above description, the amplitude of the refresh signal is the maximum amplitude of a data signal; however, the refresh signal may have an amplitude less than the maximum amplitude of a data signal to reduce power consumption. In order to achieve recovery from degradation of a liquid crystal and reduction in power consumption, the amplitude of the refresh signal may be, for example, greater than or equal to 80% and less than or equal to 100%, preferably, greater than or equal to 90% and less than or equal to 100% of the maximum amplitude of a data signal.

For example, in the case where the maximum amplitude (maximum value) of a data signal is 5 V and VCOM is −3 V, a positive/negative refresh signal is a voltage signal of +2 V/−8 V, respectively, when the amplitude of the refresh signal is 100% of the maximum amplitude; and a positive/negative refresh signal is a voltage signal of +1 V/−7 V, respectively, when the amplitude of the refresh signal is 80% of the maximum amplitude.

In the case where the same still image is displayed by the IDS drive in this embodiment, data rewriting is stopped after data is rewritten at a predetermined refresh rate. Accordingly, until the processor 111 executes a screen switching instruction, the LCD 120 continues to display the same still image without data rewriting in the pixel portion 211. If such a state continues for a long time, degradation of liquid crystal molecules might not be repaired properly by the aforementioned rewriting with the refresh signal.

Thus, to reduce the power consumption of the information processing system 100 and maintain the quality of the liquid crystal material for the LCD 120, in the case where data is retained for several to a dozen minutes (e.g., 5 minutes to 15 minutes) while a still image is displayed by the IDS drive, processing is preferably executed so that power is disconnected to shut down the LCD 120. In that case, when a predetermined period of time has elapsed after the beginning of the IDS mode, for example, the IDS mode is forced to be released in the information processing system 100 and timer interrupt processing is executed to stop the display of the LCD 120.

In the timer interrupt processing, the IDS mode may be transferred to the normal mode before the shutdown of the LCD 120, and data rewriting by a refresh signal may be performed (e.g., white or black display on the entire screen). In such a case, data rewriting by the refresh signal may be performed while a backlight unit of the LCD 120 is turned off.

As mentioned above, this embodiment provides a semiconductor device that allows eye-friendly display and power savings.

This embodiment can be implemented in combination with any of the other embodiments as appropriate.

### Embodiment 2

In this embodiment, the structure of the LCD 120 will be described more specifically.

One of the REST is the method for displaying still images by the IDS drive shown in Embodiment 1. In the IDS drive, data is retained in the pixel circuit 221 (liquid crystal cell) for a much longer period than in the normal drive. Therefore, the amount of leakage charge from the pixel circuit 221 is preferably reduced as much as possible in the IDS drive to maintain the same display quality as the normal drive. This is because the leakage charge from the pixel circuit 221 causes a change in the voltage applied to the liquid crystal element 232, thereby changing the transmittance of the pixel.

To reduce a variation in the voltage applied to the liquid crystal element 232, a transistor with a very low off-state current is preferably used as the transistor 231. In addition, a high-resistance material is preferably used as a liquid crystal material for the liquid crystal element 232.

### <Transistor in Pixel Circuit>

The off-state current of a transistor refers to a current flowing between a source and a drain of the transistor in an off state. In the off state, the gate voltage of an n-channel transistor is sufficiently lower than the threshold voltage.

The off-state current of the transistor 231 is preferably as low as possible, specifically, the off-state current per micrometer of channel width is preferably lower than or equal to 100×10⁻²¹ A (100 zA). Because the off-state current is preferably as low as possible, the normalized off-state current is preferably lower than or equal to 10 zA, more preferably lower than or equal to 1 zA, and still more preferably lower than or equal to 10×10⁻²⁴ A (10 yA).

To obtain such an extremely low off-state current, a channel of the transistor 231 may be formed using an oxide semiconductor that has a wider band gap (greater than or equal to 3.0 eV) than Si or Ge. Here, a transistor including a channel formed using an oxide semiconductor (OS) is referred to as an OS transistor.

By reducing impurities serving as electron donors, such as moisture or hydrogen, and also reducing oxygen vacancies, an i-type (intrinsic) or a substantially i-type oxide semiconductor can be obtained. Here, such an oxide semiconductor is referred to as a highly purified oxide semiconductor. When a highly purified oxide semiconductor is used for a channel, the normalized off-state current can be reduced to about several yoctoamperes per micrometer (yA/μm) to several zeptoamperes per micrometer (zA/μm).

An OS transistor preferably includes an oxide semiconductor containing at least indium (In) or zinc (Zn). The oxide semiconductor also preferably contains an element serving as a stabilizer for reducing a variation in electrical characteristics. Examples of such an element include Ga, Sn, Hf, Al, and Zr. Typical examples of the oxide semiconductor used for the OS transistor include an In—Ga—Zn-based oxide and an In—Sn—Zn-based oxide. The oxide semiconductor will be described in more detail in Embodiment 3.

### <Specific Resistivity of Liquid Crystal Material>

The resistance of the liquid crystal element 232 is preferably increased to reduce the amount of charge leaked through the liquid crystal element 232. Therefore, the specific resistivity of the liquid crystal material for the liquid crystal element 232 is preferably greater than or equal to 1.0×10¹³ Ω·cm, more preferably greater than or equal to 1.0×10¹⁴ Ω·cm. For example, it is possible to use a liquid crystal material with a specific resistivity greater than or equal to 1.0×10¹³ Ω·cm and less than or equal to 1.0×10¹⁶Ω·cm, preferably greater than or equal to 1.0×10¹⁴ Ω·cm and less than or equal to 1.0×10¹⁶ Ω·cm. Note that the specific resistivity of the liquid crystal material is measured at 20° C.

### <Liquid Crystal Mode>

There is no limitation on a driving method (liquid crystal mode) of a liquid crystal in the LCD 120. Examples of the driving method of the liquid crystal include a twisted nematic (TN) mode, a vertical alignment (VA) mode, a fringe field switching (FFS) mode, and an in-plane-switching (IPS) mode.

As the liquid crystal mode for the LC panel 200, a horizontal electric field mode such as the IPS or FFS mode is preferable to a vertical electric field mode such as the TN mode. This is because a change in gray level (transmittance of a pixel) corresponding to a change in the voltage of the pixel is more gradual in the horizontal electric field mode in displaying a half tone image. As a result, a shift in gray level can be inhibited even in a period during which data is retained by the IDS drive.

Also in the case where a touch panel is used as the input unit 130 in the information processing system 100, the horizontal electric field mode is more effective because of its high resistance to pressure. When the information processing system 100 is driven by a battery as in mobile applications, the FFS mode is preferable to the IPS mode because the pixel circuit 221 can be driven at a lower voltage.

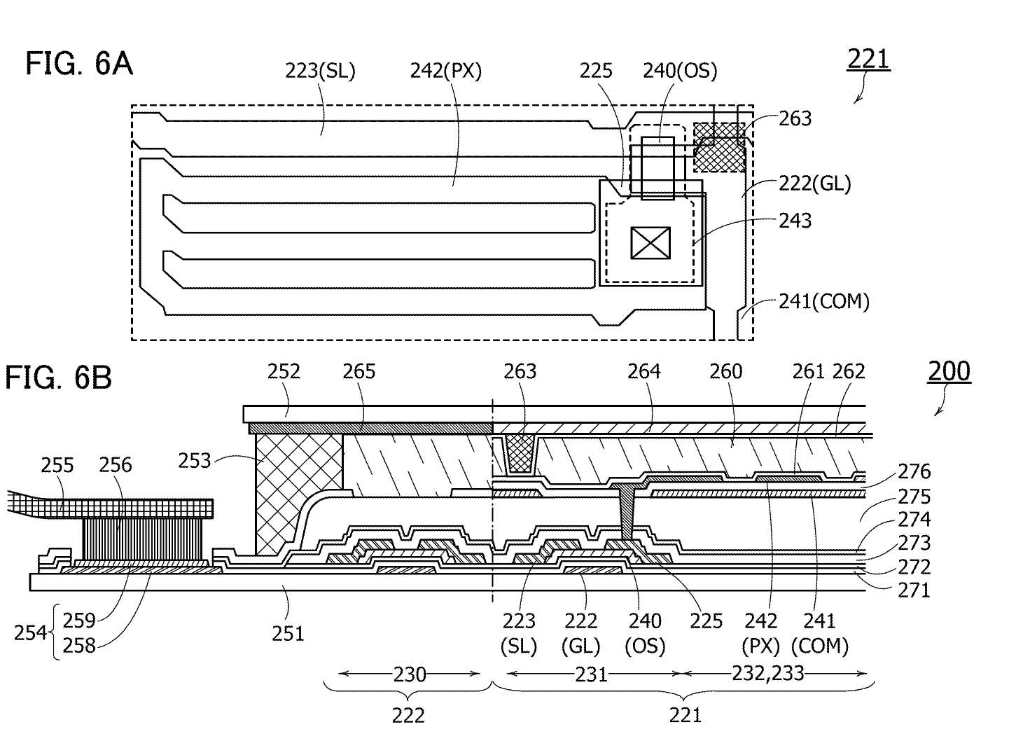

Hence, to achieve power savings and REST, the LCD using the FFS mode, the OS transistor, and the high-resistance liquid crystal material in combination is suitable for the display portion of the information processing system 100. An example of a more specific structure of the LCD 120 will be described below with reference to FIGS. 6A and 6B.

### <Example of Structure of LCD in FFS Mode>

FIGS. 6A and 6B illustrate an example of the structure of the LCD 120 in the FFS mode. FIG. 6A is a layout showing an example of a structure of the pixel circuit 221, and FIG. 6B is a cross-sectional view showing an example of a structure of the LC panel 200. Note that FIG. 6B is not a cross-sectional view taken along a certain line, but a cross-sectional view illustrating a layered structure of the LC panel 200. FIG. 6B illustrates a transistor 230 in the source driver 213 that is a typical example of the drivers (212, 213). The transistor 230 and the transistor 231 are OS transistors; here, n-channel transistors.

As illustrated in FIG. 6A, a liquid crystal layer 260 sealed by the sealing material 253 is disposed between the substrate 251 and the substrate 252. The liquid crystal layer 260 includes the aforementioned liquid crystal material with a specific resistivity greater than or equal to 1.0×10¹³ Ω·cm.

A spacer 263 maintains a cell gap of the LC panel 200. As illustrated in FIG. 6A, the spacer 263 is disposed in a region facing the substrate 251 where the gate line 222 and the source line 223 overlap with each other. In such a region, the alignment of the liquid crystal material is disordered and thus the region does not contribute to display. By forming the spacer 263 in such a region, the aperture ratio of the pixel circuit 221 can be increased. The spacer 263 may be provided over the substrate 251.

The substrate 252 is further provided with an alignment film 262, a color filter 264, and a black matrix 265. The color filter 264 is provided in a region overlapping with the pixel electrode 242. The black matrix 265 is made using an organic resin film so as to cover the region not contributing to display, such as the gate line 222, the source line 223, and the drivers (212, 213).

A terminal portion 254 including a plurality of terminals is formed on the outer side of the sealing material 253 over the substrate 251. The terminal portion 254 is connected to the FPC 255 through an anisotropic conductive film 256. The terminal portion 254 includes an electrode 258 and an electrode 259. The electrode 258 is formed using the same conductive film as the gate line 222 and a gate electrode of the transistor 230. The electrode 259 is formed using the same transparent conductive film as the common electrode 241.

The transistor 231 includes the gate line 222, the source line 223, the electrode 225, and an oxide semiconductor (OS) layer 240. The oxide semiconductor layer 240 includes at least one oxide semiconductor layer in which a channel is formed. An insulating layer 271 and an insulating layer 272 serve as gate insulating layers of the transistor 231.

The transistor 230 has the same layered structure as the transistor 231.

In FIGS. 6A and 6B, the transistor 230 and the transistor 231 are bottom-gate transistors, though they may be top-gate transistors. Alternatively, each of the transistors 230 and 231 may be a dual-gate transistor in which two gate electrodes are disposed with a channel interposed therebetween. The dual-gate OS transistor can have improved current-drive characteristics. Some of the transistors in the drivers (212, 213) may be dual-gate transistors and the others may be bottom-gate or top-gate transistors. In that case, the transistor 231 may be a dual-gate transistor or a bottom-gate or top-gate transistor.

The transistors 230 and 231 are covered with an insulating layer 273, an insulating layer 274, and an insulating layer 275. The insulating layer 275 serves as a planarization film. The insulating layer 275 can be made of an organic resin such as an acrylic resin, a polyimide resin, a benzocyclobutene-based resin, a siloxane-based resin, a polyamide resin, or an epoxy resin.

The common electrode (COM) 241 is formed over the insulating layer 275. The pixel electrode (PX) 242 is formed over the common electrode 241 with an insulating layer 276 interposed therebetween. An alignment film 261 is formed to cover the pixel electrode 242.

As illustrated in FIG. 6A, the pixel electrode 242 includes a plurality of slits so as to function as a comb-like electrode. Such a shape enables a fringe electric field including a component parallel to the substrate 251 to be generated between the common electrode 241 and the pixel electrode 242. The liquid crystal element 232 is constituted by the common electrode 241, the pixel electrode 242, and the liquid crystal layer 260, and the capacitor 233 is constituted by the common electrode 241, the pixel electrode 242, and the insulating layer 276. That is, in the pixel circuit 221 using the FFS mode, an auxiliary capacitor can be added in parallel with the liquid crystal element 232 without forming an auxiliary capacitor line which reduces the aperture ratio. Such a structure is suitable for an increase in resolution.

The common electrode 241 includes an opening 243 in a region overlapping with the electrode 225. The insulating layers 273 to 275 include a contact hole in a region overlapping with the opening 243 in the common electrode 241. The pixel electrode 242 is in contact with the electrode 225 through the contact hole.

This embodiment can be implemented in combination with any of the other embodiments as appropriate.

### Embodiment 3

Described in this embodiment is an oxide semiconductor used for a channel of an OS transistor.

Examples of the oxide semiconductor used for the OS transistor include indium oxide, tin oxide, zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, and an In—Hf—Al—Zn-based oxide.

An OS transistor preferably includes an oxide semiconductor containing at least indium (In) or zinc (Zn). The oxide semiconductor also preferably contains an element serving as a stabilizer for reducing a variation in electrical characteristics. Examples of such an element include Ga, Sn, Hf, Al, and Zr. Typical examples of the oxide semiconductor used for the OS transistor include an In—Ga—Zn-based oxide and an In—Sn—Zn-based oxide.

Here, an “In—Ga—Zn-based oxide” means an oxide containing In, Ga, and Zn as its main components and there is no limitation on the ratio of In to Ga and Zn. The In—Ga—Z-based oxide may contain another metal element in addition to In, Ga, and Zn.

Alternatively, a material represented by InMO₃(ZnO)ₘ (m>0) may be used as an oxide semiconductor. Note that M represents one or more metal elements selected from Ga, Fe, Mn, and Co, or the above element as a stabilizer. Still alternatively, a material represented by In₂SnO₅(ZnO)ₙ (n>0) may be used as the oxide semiconductor.

For example, an In—Ga—Zn-based oxide in which an atomic ratio of In to Ga and Zn is 1:1:1, 1:3:2, 3:1:2, or 2:1:3, or an oxide whose composition is in the neighborhood of the above compositions may be used.

When an oxide semiconductor film contains a large amount of hydrogen, the hydrogen and an oxide semiconductor are bonded to each other, so that part of the hydrogen serves as a donor to generate an electron which is a carrier. As a result, the threshold voltage of the transistor shifts in the negative direction. It is thus preferable that, after the formation of the oxide semiconductor film, dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Therefore, it is preferable that oxygen be added to the oxide semiconductor film to fill oxygen vacancies increased by the dehydration treatment (dehydrogenation treatment). Here, supplying oxygen to an oxide semiconductor film may be expressed as oxygen adding treatment or treatment for making an oxygen-excess state.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) highly purified oxide semiconductor film or a substantially i-type (intrinsic) highly purified oxide semiconductor film which is extremely close to an i-type oxide semiconductor film. Note that “substantially intrinsic” means that the oxide semiconductor film contains extremely few (close to zero) carriers derived from a donor and has a carrier density lower than or equal to 1×10¹⁷/cm³, lower than or equal to 1×10¹⁶/cm³, lower than or equal to 1×10¹⁵/cm³, lower than or equal to 1×10¹⁴/cm³, or lower than or equal to 1×10¹³/cm³.

### <Structure of Oxide Semiconductor Film>

A structure of the oxide semiconductor film will be described below.

An oxide semiconductor film is classified roughly into a single-crystal oxide semiconductor film and a non-single-crystal oxide semiconductor film. The non-single-crystal oxide semiconductor film includes any of an amorphous oxide semiconductor film, a microcrystalline oxide semiconductor film, a polycrystalline oxide semiconductor film, a c-axis aligned crystalline oxide semiconductor (CAAC-OS) film, and the like.

An oxide semiconductor film of an OS transistor may be a single-layer film or a layered film including two or more films of an amorphous oxide semiconductor film, a microcrystalline oxide semiconductor film, and a CAAC-OS film, for example.

### <CAAC-OS Film>

The CAAC-OS film will be described in detail below. The CAAC-OS film is one of oxide semiconductor films having a plurality of c-axis aligned crystal parts.

When a combined analysis image (also referred to as a high-resolution TEM image) of a bright-field image and a diffraction pattern of the CAAC-OS film is observed by a transmission electron microscope (TEM), a plurality of crystal parts are seen. However, a boundary between crystal parts, that is, a grain boundary is not clearly observed even in the high-resolution TEM image. Thus, in the CAAC-OS film, a reduction in electron mobility due to the grain boundary is less likely to occur.

In the high-resolution cross-sectional TEM image of the CAAC-OS film observed in a direction substantially parallel to the sample surface, metal atoms are arranged in a layered manner in the crystal parts. Each metal atom layer has a morphology reflected by a surface over which the CAAC-OS film is formed (hereinafter, a surface over which the CAAC-OS film is formed is referred to as a formation surface) or a top surface of the CAAC-OS film, and is arranged in parallel to the formation surface or the top surface of the CAAC-OS film.

In the high-resolution planar TEM image of the CAAC-OS film observed in a direction substantially perpendicular to the sample surface, metal atoms arranged in a triangular or hexagonal configuration are seen in the crystal parts. However, there is no regularity in arrangement of metal atoms between different crystal parts.

From the high-resolution cross-sectional TEM image and the high-resolution planar TEM image, orientation characteristics are found in the crystal parts in the CAAC-OS film.

In an electron diffraction pattern of the CAAC-OS film, spots (bright spots) having orientation characteristics are shown. For example, when electron diffraction with an electron beam having a diameter of, for example, 1 nm or more and 30 nm or less (such electron diffraction is also referred to as nanobeam electron diffraction) is performed on the top surface of the CAAC-OS film, the spots are observed. In the case where the oxide semiconductor film has a plurality of structures, the structures can be analyzed using nanobeam electron diffraction in some cases.

The CAAC-OS film is one of oxide semiconductor films including a plurality of crystal parts, and most of the crystal parts each fit inside a cube whose one side is less than 100 nm. Thus, there is a case where a crystal part included in the CAAC-OS film fits inside a cube whose one side is less than 10 nm, less than 5 nm, or less than 3 nm. The density of defect states of the CAAC-OS film is lower than that of the microcrystalline oxide semiconductor film. The CAAC-OS film will be described in detail below.

A CAAC-OS film is subjected to structural analysis with an X-ray diffraction (XRD) apparatus. For example, when the CAAC-OS film including an InGaZnO₄ crystal is analyzed by an out-of-plane method, a peak appears when the diffraction angle (2θ) is around 31°. Since this peak is derived from the (009) plane of the InGaZnO₄ crystal, it can also be confirmed that crystals in the CAAC-OS film have c-axis alignment and that the c-axes are aligned in a direction substantially perpendicular to the formation surface or the top surface of the CAAC-OS film.

On the other hand, when the CAAC-OS film is analyzed by an in-plane method in which an X-ray enters a sample in a direction substantially perpendicular to the c-axis, a peak appears frequently when 2θ is around 56°. This peak is derived from the (110) plane of the InGaZnO₄ crystal. Here, analysis (φ scan) is performed under conditions where the sample is rotated around a normal vector of a sample surface as an axis (φ axis) with 2θ fixed at around 56°. In the case where the sample is a single-crystal oxide semiconductor film of InGaZnO₄, six peaks appear. The six peaks are derived from crystal planes equivalent to the (110) plane. On the other hand, in the case of a CAAC-OS film, a peak is not clearly observed even when φ scan is performed with 2θ fixed at around 56°.

According to the above results, in the CAAC-OS film having c-axis alignment, while the directions of a-axes and b-axes are different between crystal parts, the c-axes are aligned in a direction parallel to a normal vector of a formation surface or a normal vector of a top surface. Thus, each metal atom layer arranged in a layered manner observed in the high-resolution cross-sectional TEM image corresponds to a plane parallel to the a-b plane of the crystal.

Note that the crystal part is formed concurrently with deposition of the CAAC-OS film or is formed through crystallization treatment such as heat treatment. As described above, the c-axes of the crystal part are aligned in a direction parallel to a normal vector of a formation surface or a normal vector of a top surface. Thus, for example, in the case where the shape of the CAAC-OS film is changed by etching or the like, the c-axes of the crystal part might not be necessarily parallel to a normal vector of a formation surface or a normal vector of a top surface of the CAAC-OS film.

The degree of crystallinity in the CAAC-OS film is not necessarily uniform. For example, in the case where crystal growth leading to the CAAC-OS film occurs from the vicinity of the top surface of the film, the degree of the crystallinity in the vicinity of the top surface is higher than that in the vicinity of the formation surface in some cases. Furthermore, when an impurity is added to the CAAC-OS film, the crystallinity in a region to which the impurity is added is changed, and the degree of crystallinity in the CAAC-OS film varies depending on regions.

Note that when the CAAC-OS film including an InGaZnO₄ crystal is analyzed by an out-of-plane method, a peak of 2θ may also be observed at around 36°, in addition to the peak of 2θ at around 31°. The peak of 2θ at around 36° indicates that a crystal part having no c-axis alignment is included in part of the CAAC-OS film. It is preferable that in the CAAC-OS film, a peak of 20 appear at around 31° and a peak of 2θ do not appear at around 36°.

The CAAC-OS film is an oxide semiconductor film having low impurity concentration. The impurity is an element other than the main components of the oxide semiconductor film, such as hydrogen, carbon, silicon, or a transition metal element. In particular, an element that has higher bonding strength to oxygen than a metal element included in the oxide semiconductor film, such as silicon, disturbs the atomic arrangement of the oxide semiconductor film by depriving the oxide semiconductor film of oxygen and causes a decrease in crystallinity. Furthermore, a heavy metal such as iron or nickel, argon, carbon dioxide, or the like has a large atomic radius (molecular radius), and thus disturbs the atomic arrangement of the oxide semiconductor film and causes a decrease in crystallinity when it is contained in the oxide semiconductor film. Note that the impurity contained in the oxide semiconductor film might serve as a carrier trap or a carrier generation source. The CAAC-OS film is an oxide semiconductor film having a low density of defect states. In some cases, oxygen vacancies in the oxide semiconductor film serve as carrier traps or serve as carrier generation sources when hydrogen is captured therein.

A transistor using the CAAC-OS film has little variation in electrical characteristics due to irradiation with visible light or ultraviolet light, and thus, the transistor has high reliability.

In this specification, the term “parallel” indicates that the angle formed between two straight lines is greater than or equal to −10° and less than or equal to 10°, and accordingly also includes the case where the angle is greater than or equal to −5° and less than or equal to 5°. In addition, the term “perpendicular” indicates that the angle formed between two straight lines is greater than or equal to 80° and less than or equal to 100°, and accordingly includes the case where the angle is greater than or equal to 85° and less than or equal to 95°.

For example, a CAAC-OS film is deposited by a sputtering method using a polycrystalline metal oxide target. When ions collide with the target, a crystal region included in the target might be separated from the target along the a-b plane, and a sputtered particle having a plane parallel to the a-b plane (flat-plate-like or pellet-like sputtered particle) might be separated from the target. In that case, the flat-plate-like or pellet-like sputtered particle reaches a substrate while maintaining its crystal state, so that the CAAC-OS film can be deposited.

For the deposition of the CAAC-OS film, the following conditions are preferably employed.

By reducing the amount of impurities entering the CAAC-OS film during the deposition, the crystal state can be prevented from being broken by the impurities. For example, the concentration of impurities (e.g., hydrogen, water, carbon dioxide, or nitrogen) which exist in a treatment chamber may be reduced. The concentration of impurities in a deposition gas may also be reduced. Specifically, a deposition gas whose dew point is −80° C. or lower, preferably −100° C. or lower is used.

By increasing the substrate heating temperature during the deposition, when the flat-plate-like or pellet-like sputtered particle reaches the substrate, migration occurs on the substrate surface, so that a flat plane of the sputtered particle is attached to the substrate. For example, the substrate heating temperature during the deposition may be higher than or equal to 100° C. and lower than or equal to 740° C., preferably higher than or equal to 200° C. and lower than or equal to 500° C.

Furthermore, it is preferable to reduce plasma damage during the deposition by increasing the proportion of oxygen in the deposition gas and optimizing power. The proportion of oxygen in the deposition gas is higher than or equal to 30 vol %, preferably 100 vol %.

### <Microcrystalline Semiconductor Film>

A microcrystalline oxide semiconductor film has a region where a crystal part is observed in a high resolution TEM image and a region where a crystal part is not clearly observed in a high resolution TEM image. In most cases, a crystal part in the microcrystalline oxide semiconductor film is, for example, greater than or equal to 1 nm and less than or equal to 10 nm. A microcrystal with a size greater than or equal to 1 nm and less than or equal to 10 nm, or a size greater than or equal to 1 nm and less than or equal to 3 nm is specifically referred to as nanocrystal (nc). An oxide semiconductor film including nanocrystal is referred to as an nc-OS (nanocrystalline oxide semiconductor) film. In a high resolution TEM image of the nc-OS film for example, a grain boundary cannot be found clearly in the nc-OS film in some cases.

The nc-OS film is an oxide semiconductor film that has high regularity as compared to an amorphous oxide semiconductor film. Therefore, the nc-OS film has a lower density of defect states than an amorphous oxide semiconductor film. Note that there is no regularity of crystal orientation between different crystal parts in the nc-OS film. Therefore, the nc-OS film has a higher density of defect states than the CAAC-OS film.

### <Amorphous Oxide Semiconductor Film>

The amorphous oxide semiconductor film has disordered atomic arrangement and no crystal part. For example, the amorphous oxide semiconductor film does not have a specific state as in quartz.

In the high-resolution TEM image of the amorphous oxide semiconductor film, crystal parts cannot be found. When the amorphous oxide semiconductor film is subjected to structural analysis by an out-of-plane method with an XRD apparatus, a peak which shows a crystal plane does not appear. A halo pattern is shown in an electron diffraction pattern of the amorphous oxide semiconductor film. Furthermore, a halo pattern is shown but a spot is not shown in a nanobeam electron diffraction pattern of the amorphous oxide semiconductor film.

This embodiment can be implemented in combination with any of the other embodiments as appropriate.

### Embodiment 4

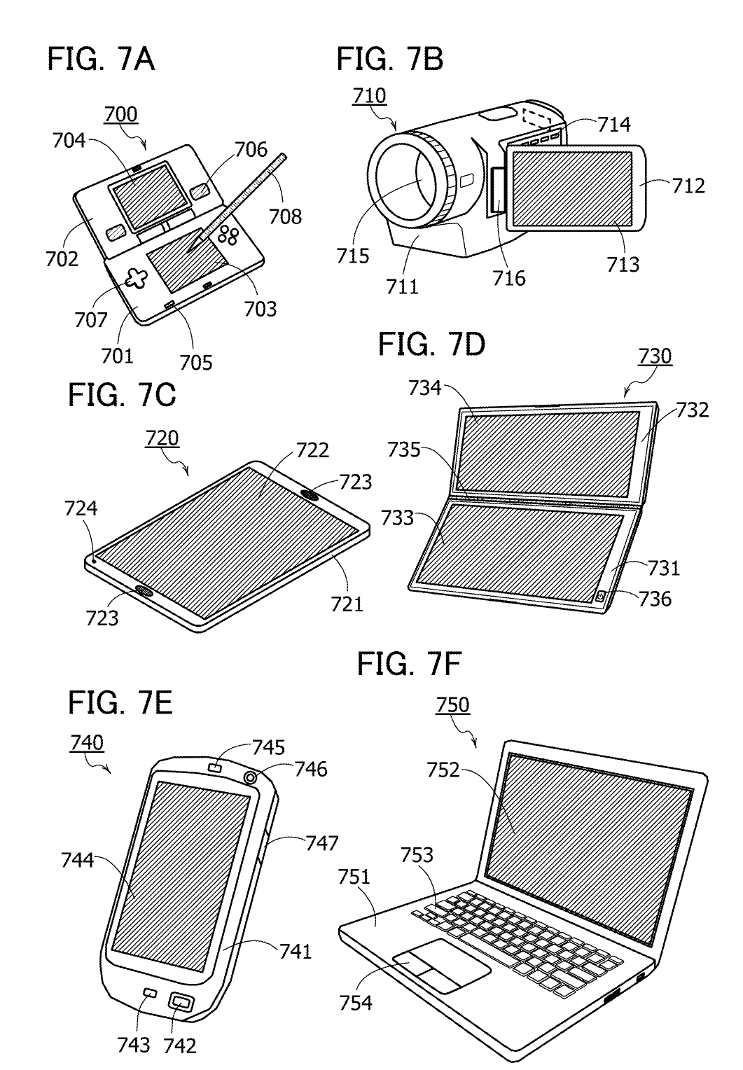

In this embodiment, some specific examples of the information processing system 100 will be described with reference to FIGS. 7A to 7F. FIGS. 7A to 7F are external views illustrating examples of the information processing system including an LCD in a display portion.

FIG. 7A illustrates a portable game machine 700, which includes a housing 701, a housing 702, a display portion 703, a display portion 704, a microphone 705, speakers 706, a control key 707, a stylus 708, and the like. The display portion 703 and/or the display portion 704 may include a touch panel as the input unit 130.

A video camera 710 in FIG. 7B includes a housing 711, a housing 712, a display portion 713, operation keys 714, a lens 715, a joint 716, and the like. The operation keys 714 and the lens 715 are provided in the housing 711, and the display portion 713 is provided in the housing 712. The housing 711 and the housing 712 are connected to each other with the joint 716, and the angle between the housing 711 and the housing 712 can be changed with the joint 716. An image on the display portion 713 may be switched depending on the angle between the housing 711 and the housing 712 at the joint 716. The display portion 713 may include a touch panel.

A tablet 720 in FIG. 7C includes a display portion 722 incorporated in a housing 721, an operation button 723, and a speaker 724. In addition, although not illustrated, the tablet 720 includes a microphone, a stereo headphone jack, a memory card insertion slot, a camera, an external connection port such as a USB connector, and the like. The display portion 722 includes a touch panel as the input unit 130.

A foldable tablet 730 illustrated in FIG. 7D includes a housing 731, a housing 732, a display portion 733, a display portion 734, a connection portion 735, an operation button 736, and the like. The display portion 733 and the display portion 734 each include the LCD 120. The display portion 733 and the display portion 734 each include a touch panel as the input unit 130.

A smartphone 740 illustrated in FIG. 7E includes a housing 741, an operation button 742, a microphone 743, a display portion 744, a speaker 745, a camera lens 746, and the like. Since the camera lens 746 is provided on the same plane as the display portion 744, videophone is possible. The display portion 744 includes a touch panel as the input unit 130.

A laptop personal computer 750 illustrated in FIG. 7F includes a housing 751, a display portion 752, a keyboard 753, a pointing device 754, and the like. The display portion 752 includes the LCD 120. The display portion 752 may also include a touch panel as the input unit 130.

This embodiment can be implemented in combination with any of the other embodiments as appropriate.

This application is based on Japanese Patent Application serial No. 2013-125206 filed with Japan Patent Office on Jun. 14, 2013, the entire contents of which are hereby incorporated by reference.

What is claimed is:

1. A method for driving a display device including a pixel comprising a transistor, the method including steps of:
in a first frame, applying a first voltage to a first terminal of the transistor;
in a second frame, applying a second voltage to the first terminal of the transistor;
in a third frame, applying a third voltage to the first terminal of the transistor; and
in a fourth frame, turning off the transistor,
wherein the first voltage and the third voltage are different in potential from each other,
wherein the second voltage is greater than or equal to 80% and less than or equal to 100% of the first voltage, and
wherein the first to the fourth frames are sequential.

2. The method for driving a display device according to claim 1,
wherein the second voltage is an inverted voltage of the first voltage.

3. The method for driving a display device according to claim 1,
wherein a still image is displayed during the third frame and the fourth frame.

4. The method for driving a display device according to claim 1,
wherein the pixel comprises a liquid crystal material having a specific resistivity greater than or equal to 1.0×10¹³ Ω·cm.

5. The method for driving a display device according to claim 1,
wherein the display device is driven by a fringe field switching mode.

6. The method for driving a display device according to claim 1,
wherein the transistor comprises an oxide semiconductor.

7. A method for driving a display device including a pixel comprising a transistor, the method including steps of:
in a first frame, applying a first voltage to a first terminal of the transistor;
in a second frame, applying a second voltage to the first terminal of the transistor;
in a third frame, turning off the transistor; and
in a fourth frame, applying a third voltage to the first terminal of the transistor,
wherein the first voltage and the second voltage are different in potential from each other,
wherein the third voltage is greater than or equal to 80% and less than or equal to 100% of the second voltage, and
wherein the first to the third frames are sequential.

8. The method for driving a liquid crystal display device according to claim 7,
wherein the third voltage is an inverted voltage of the first voltage.

9. The method for driving a display device according to claim 7,
wherein a still image is displayed during the second frame and the third frame.

10. The method for driving a display device according to claim 7,
wherein the pixel further comprises a liquid crystal material having a specific resistivity greater than or equal to 1.0×10¹³ Ω·cm.

11. The method for driving a display device according to claim 7,
wherein the display device is driven by a fringe field switching mode.

12. The method for driving a display device according to claim 7,
wherein the transistor comprises an oxide semiconductor.
